(19) United States
(12) Patent Application Publication
(10) Pub. No.: US 2017/0214634 A1
(43) Pub. Date: Jul. 27, 2017

(54) JOINT AUTOSCALING OF CLOUD APPLICATIONS

(71) Applicant: Futurewei Technologies, Inc., Plano, TX (US)

(72) Inventor: Li Li, Bridgewater, NJ (US)

(21) Appl. No.: 15/006,707

(22) Filed: Jan. 26, 2016

(51) Int. Cl. H04L 12/911; G06F 9/50; H04L 29/08

(52) U.S. Cl. CPC H04L 47/829; H04L 67/10; H04L 47/827; G06F 9/5077

(57) ABSTRACT

A method includes receiving runtime metrics for a distributed application, the distributed application utilizing cloud resources including computer nodes and network links, detecting a change in the runtime metrics, determining nodes and links associated with the distributed application utilizing an application topology description data structure, and jointly scaling the links and nodes responsive to the detected change in the runtime metrics.

### FIELD OF THE INVENTION

The present disclosure is related to auto-scaling of cloud based resources for applications and in particular to joint auto-scaling of cloud based node and link resources for applications.

### BACKGROUND

Many applications are performed by resources accessed by a user via a network. Such resources and connections between them may be provided by a cloud. The cloud allocates nodes containing resources to execution of the application and the nodes may be scaled up or down based on the volume of use of the application, referred to as workload. If the workload increases, more resources may be allocated to performing the application. The workload may increase due to more users using the application, the existing user increasing their use, or both. Similarly, the workload may decrease such that fewer resources may be allocated or provisioned to the application.

Current auto-scaling services and approaches scale nodes in isolation. Connections to and between nodes providing resources such as a virtual machine (VM) for an application in a cloud based system may also be scaled in isolation. Scaling the VM nodes without scaling the links between them results in insufficient or wasted network resources. Each of the nodes and links may implement their own scaling policies that react to their workload measurements. Increasing resources in one node may result in changes in workload that occur in other nodes, which then increase their resources.

### SUMMARY

A method includes receiving runtime metrics for a distributed application, the distributed application utilizing cloud resources including computer nodes and network links, detecting a change in the runtime metrics, determining nodes and links associated with the distributed application utilizing an application topology description data structure, and jointly scaling the links and nodes responsive to the detected change in the runtime metrics.

A computer implemented auto-scaling system includes processing circuitry, a storage device coupled to the processing circuitry, and auto-scaling code stored on the storage device for execution by the processing circuitry to perform operations. The operations include receiving runtime metrics for a distributed application, the distributed application utilizing cloud resources including computer nodes and network links, detecting a change in the runtime metrics, determining nodes and links associated with the distributed application utilizing an application topology description data structure, and jointly scaling the links and nodes responsive to the detected change in the runtime metrics.

A non-transitory storage device having instructions stored thereon for execution by processor to cause the processor to perform operations including receiving runtime metrics for a distributed application, the distributed application utilizing cloud resources including computer nodes and network connections, detecting a change in the runtime metrics, determining nodes and links associated with the distributed application utilizing an application topology description data structure, and jointly scaling the links and nodes responsive to the detected change in distributed application workload metrics.

### BRIEF DESCRIPTION OF THE DRAWINGS

FIG. 1 is a block diagram illustrating a system providing a tiered network based distributed application service to a user according to an example embodiment.

FIG. 2 is a flowchart illustrating a method of jointly auto-scaling node and link resources responsive to workload measurement and a joint auto-scaling policy according to an example embodiment.

FIG. 3 is a block diagram illustrating components involved in auto-scaling nodes and links associated with a distributed application responsive to application workload metrics according to an example embodiment.

FIG. 4 is a graph of a set of nodes and links provisioned for a distributed application with a current total capacity of 28 where the under-provisioned nodes and links are identified by a cut across the graph in accordance with an application scale-up algorithm in FIG. 6 according to an example embodiment.

FIG. 5 is a graph illustrating increased capacity of the under-provisioned nodes and links to meet a target total capacity 40 in accordance with an application scale-up algorithm in FIG. 6 according to an example embodiment.

FIG. 6 is a pseudocode representation illustrating an application scale-up method that determines the total increased capacity and the under-provisioned nodes and links whose capacities should be increased, and increases their capacities to meet the total increased capacity according to an example embodiment.

FIG. 7 is a graph illustrating a current capacity along with a cost, and a maximum capacity for each link that serve as the input to a link-node scale-up algorithm in FIG. 9 according to an example embodiment.

FIG. 8 is a graph illustrating changes to the FIG. 7 graph in accordance with a link-node scale-up algorithm in FIG. 9 to meet a total increased capacity of 12 according to an example embodiment.

FIG. 9 is a pseudocode representation of a link-node scale-up method of increasing capacities of under-provisioned links and nodes to meet a total increased capacity according to an example embodiment.

FIG. 10 is a pseudocode representation of a method of allocating a total increased capacity among the under-provisioned links to minimize cost increases associated with the increased link capacities according to an example embodiment.

FIG. 11 is a graph illustrating the complement graph of an application used to determine the total decreased capacity of the application according to an example embodiment.

FIG. 12 is a graph illustrating the over-provisioned nodes and links identified by a cut across the complement graph whose current total capacity is 65 in accordance with an application scale-down algorithm in FIG. 13 according to an example embodiment.

FIG. 13 is a pseudocode representation of an application scale-down method that determines the total decreased capacity and the over-provisioned nodes and links whose capacities should be decreased, and decreases their capacities to meet the total decreased capacity according to an example embodiment.

FIG. 14 is a graph illustrating the current capacity, cost and maximum capacity of the over-provisioned links and nodes that serve as the input to a link-node scale-down method in FIG. 16 according to an example embodiment.

FIG. 15 is a graph that illustrates the changes to the link capacities in accordance with a link-node scale-down algorithm in FIG. 17 to meet the target total capacity of 45 (or total decreased capacity of 20) according to an example embodiment.

FIG. 16 is a pseudocode representation of a link-node scale-down method of decreasing capacities of over-provisioned links and nodes to meet a total decreased capacity according to an example embodiment.

FIG. 17 is a pseudocode representation of a method of allocating the total decreased capacity among the over-provisioned links to maximize cost decreases associated with the decreased link capacities to meet a total decreased capacity according to an example embodiment.

FIG. 18 is a YAML (yet another markup language) representation illustrating changes to TOSCA (Topology and Orchestration Specification for Cloud Applications) for representing the topology and performance metrics of a distributed application needed by the auto-scaling method according to an example embodiment.

FIG. 19 is a YAML representation illustrating a joint auto-scaling policy where a scale method and scale objects have been added according to an example embodiment.

FIG. 20 is a block diagram illustrating circuitry for clients, servers, cloud based resources for implementing algorithms and performing methods according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

Current auto-scaling services and approaches scale nodes in isolation. Links to and between nodes providing resources such as a virtual machine (VM) for an application in a cloud based system may also be scaled in isolation. Scaling the VM nodes without scaling the links between them results in insufficient or wasted network resources. While capacity of a node, such as the number of central processing units (CPUs) and memory may be increased or decreased, the scaling policies of different VM are not coordinated. In the case of a distributed application, where different functions of the application may be performed on different nodes, modifying the capacity at a first node may result in a need for changing the capacity at other nodes. However, a delay may occur as workloads changes are detected only when the first node capacity change results in a cascading workload change at the other nodes.

FIG. 1 is a block diagram illustrating a system 100 providing a tiered network based distributed application service to a user 110. System 100 includes multiple tiers indicated at 115, 120 and 125 providing different services associated with the distributed application. For example, a first tier 115 may include resources dedicated to providing user interface services for the application. First tier 115 may include multiple nodes, each having one or more VMs as resources, two of which are indicated, providing the interface services. A second tier 120 may include resources, five VM indicated, for performing computational functions for the distributed application. A third tier 125 may include resources, three VM indicated, for providing data storage services associated with the distributed application.

Each tier may consist of multiple nodes and multiple resources at each node, and many other different types of application services may be associated with the tiers in further embodiments. Communication connections between the users 110 and tiers/nodes are indicated at 130, 135, and 140. Note that with additional tiers and nodes which may be present in provisioning larger applications, the number of connections between nodes may be significantly larger than in the simple example shown.

In prior systems, each tier may have its own VM scaling policy that operates in reaction to workload changes. Similarly, communication links may also have their own scaling policies reacting to changes in bandwidth utilization. Such scaling may be referred to as reactive scaling. Scaling the VM and links in reaction to, not ahead of, workload changes results in reduced performance or wasted resources due to scaling delay.

Scaling delay may include the time to make a decision to react, determining resources to add, booting and rebooting VM. In the case of reducing resources, the delays may be associated with taking a snapshot of a resource to be reduced and deleting the resource. The delays are amplified where resources may be changed at short time intervals. Further, changing the node capacities without changing the capacities of the links between the node may result in still further delay as separate link scaling occurs only when the increase in node capacities result in different communication loads on the links.

In system 100, a joint auto-scaling policy 150 is shown which provides a policy for proactively and jointly scaling the resources at nodes and the connections between the nodes. In other words, scaling of resources may begin prior to workload changes reaching different nodes based on overall workload metrics, also referred to as runtime metrics.

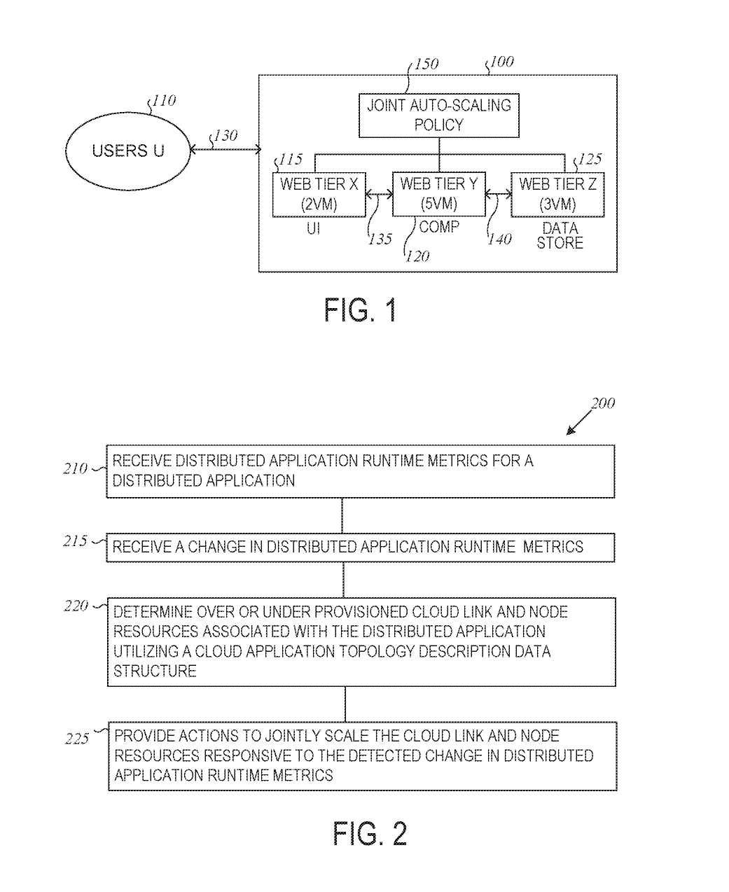

In one embodiment, the joint auto-scaling policy is used by an auto-scaling system, to perform a method 200 of auto-scaling the node resources and links as illustrated in flowchart form in FIG. 2. The auto-scaling system performs operations including receiving distributed application workload metrics for a distributed application at 210, where the distributed application utilizes cloud resources and network connections to perform services for users using the distributed application via a network, such as the Internet.

At 215, a change in distributed application workload metrics is received. A workload measurement system may be observing the workload and providing resource utilization metrics such as for example, frequency of transactions and time to perform transactions, and various quality of service (QoS) measurements. The metrics may be defined by a user or administrator in various embodiments. At 220, cloud resources and network connections associated with the distributed application are determined utilizing a cloud resources and connections topology description data structure. The data structure may be provided by an application administrator, and may be in the form of a mark-up language that describes the structure of the nodes and connections that are used to perform the distributed application.

In one embodiment, the data structure specifies a joint auto-scaling policy and parameters of the distributed application, also referred to as a cloud application in OASIS TOSCA (Topology and Orchestration Specification for Cloud Applications).

At 225, actions to jointly scale the links and nodes of an application may be provided responsive to the detected change in distributed application workload metrics. The actions may specify the link and node resources to increase or decrease in accordance with the auto-scaling policy associated with the distributed application. The actions may use resource management application programming interfaces (APIs) to update link and node capacities for the distributed application.

In one embodiment, the cloud resources are adjusted at multiple nodes of an application. The links between the nodes may be scaled by adjusting the network bandwidth between the multiple nodes.

The application topology description data structure includes an initial reference value for the workload metrics for the distributed application.

In one embodiment, the application topology description data structure further includes link capacities, node capacities, link capacity limits, node capacity limits, link cost, node cost, source node, and sink node.

Joint link-node auto-scaling of an application may be performed using an integral control algorithm to calculate a target total capacity based on current application metrics and a pair of high and low threshold metrics.

The distributed application in one embodiment comprises a tiered web application with different nodes performing different functions of the web application. The nodes and links between the nodes are scaled jointly in accordance with an auto-scaling policy. Capacities of under-provisioned links and nodes are increased such that cost increase of the links and nodes is minimized. Capacities of over-provisioned links and nodes are decreased such that cost decrease of the links and nodes is maximized.

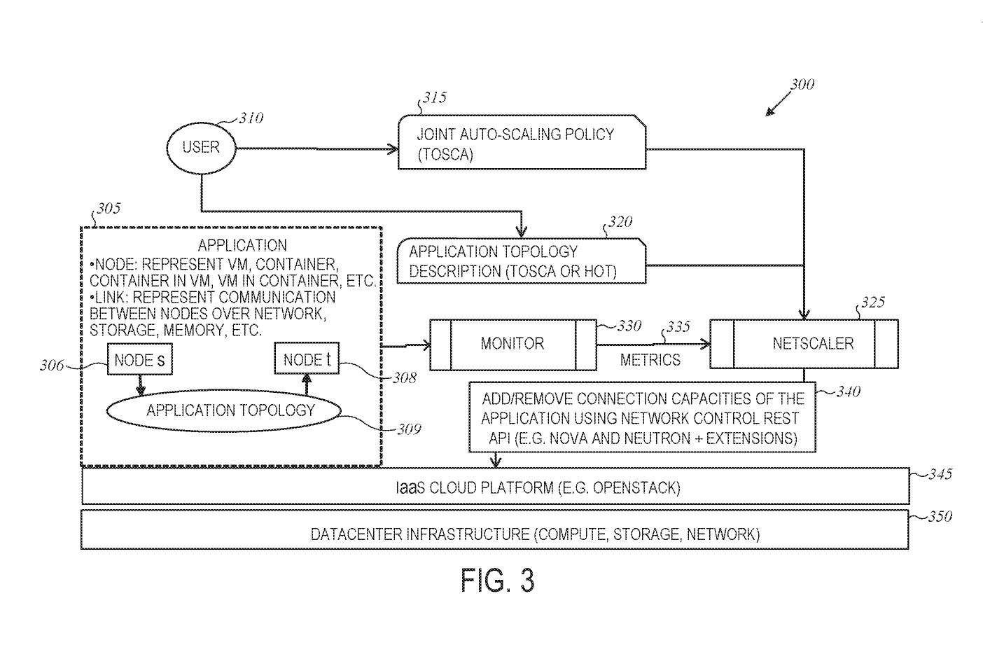

FIG. 3 is a block diagram illustrating generally at 300, components involved in auto-scaling nodes and connections associated with a distributed application 305 responsive to application workload metrics. The distributed application may utilize cloud based resources including nodes, which represent VM, containers, containers in VM, and other resources such as storage involved in executing the application. Links represent communications between the nodes over the network, including links to storage, memory and other resources.

The distributed application 305 is illustrated with a logical representation of cloud resources used to execute the application. A source node is shown at 306 coupled to an application topology 307 and a sink node at 308. In one embodiment, a user 310, such as an administrator or managing system, provides a joint auto-scaling policy 315 and an application topology description 320 to a network scaling service 325. A monitor 330 is used to monitor workload of the distributed application 305 and continuously provides workload metrics as they are generated via a connection 335 to the network scaling service 325. An existing network scaling service 325 may be used and modified to provide joint proactive scaling of both node and links of the distributed application responsive to the provided metrics and joint auto-scaling policy 315.

Auto-scaling decisions of the scaling service 325 are illustrated at 340, and may include adding or removing link capacities of the distributed application using network control representational state transfer (REST) APIs (e.g., Nova and Neutron+extensions) for example. The decisions 340 are provided to an infrastructure as a service (IaaS) cloud platform, such as for example OpenStack, which then performs the decisions on a datacenter infrastructure 350 that comprises the nodes and links executing the distributed application as deployed by user 310. Note that the infrastructure 350 may include networked resources at a single physical location, or multiple networked machines at different physical locations as is common in cloud based provisioning of distributed applications. The infrastructure 350 may also host the scaling service 325 which may also include the monitor 330.

In one embodiment, application topology 320 is converted into an application model for use by the scaling service 325. The application model may be expressed as G=(N, E, A, C, L, s, t), where:

N={nᵢ|nᵢ is a node}

E={eⱼᵢ|eᵢⱼ is a link from node nᵢ to node nⱼ in E}

Aₖ={aᵢⱼ|aᵢⱼ1>0 is the link capacity of eᵢⱼ at time k}

Bₖ={bᵢ|bᵢ>0 is the node capacity of nᵢ at time k}

CE={cᵢⱼ|cᵢⱼ>0 is the link capacity cost of eᵢⱼ}

LE={lᵢⱼlᵢⱼ≧aᵢⱼ is the maximum capacity of link eᵢⱼ}

CN={cᵢ|cᵢ>0 is the capacity cost of nᵢ}

LN={lᵢ|lᵢ≧cᵢ is the maximum capacity of node nᵢ}

s is the source node of E that generates input to N and

t is the sink node of E that receives output from N

The total cost of the application model G is the sum {aᵢⱼcᵢⱼ for all eᵢⱼ in E}+sum{bᵢcᵢ for all nᵢ in N}. The joint auto-scaling policy 315 specifies M_{ref}, A₀, B₀, LE, LN, s, and t, where M_{ref}, is an initial value of the metrics. The measured metrics at time k are represented by Mₖ, and as indicated above, may include various QoS and resource utilization metrics. The application model, joint policy, and measured metrics are provided to the scaling service 325, which may implement a modified form of integral control in one embodiment where:
Mₕ: high-metrics threshold
Mₗ: low-metrics threshold
K: integral control coefficient
Uₖ: total capacity of G at time k

1. Uₖ₊₁=Uₖ+K(Mₜ−Mₖ) if Mₖ<Mₗ (scale up)

2. Uₖ₊₁=Uₖ−K(Mₖ−Mₕ) if Mₖ>Mₕ (scale down)

3. Uₖ₊₁=Uₖ (do nothing)

4. Uᵢ=capacity(min_cut(G, Aᵢ)) for i=k, k+1

The integral control coefficient, K, is used to control how quickly scaling occurs in response to changes in the measurement metrics. Note that the first three potential actions, scale up, scale down, and do nothing are dependent on if the measured metrics Mₖ is below the low threshold Mₗ, above the high threshold Mₕ, or within the thresholds respectively. In each case, a target total capacity at time k+1 is calculated based on the current total capacity Uₖ at time k plus a total increased capacity, minus a total decrease capacity, or without any change. The total increased capacity K(Mₖ−Mₖ) is the difference between the low threshold and the measured metrics times the integral control coefficient, while the total decreased capacity K(Mₖ−Mₕ) is the difference between the measured metrics and the high threshold times the integral control coefficient. The fourth potential action calculates the current total capacity Uₖ from the application topology and associates the target total capacity Uₖ₊₁ to the application topology by a min_cut function as described in further detail below. In one embodiment, the decisions 340 include API calls to allocate link-node capacities by matrix Aₖ₊₁ that define new link capacities and vector Bₖ₊₁ that defines the new node capacities for the application.

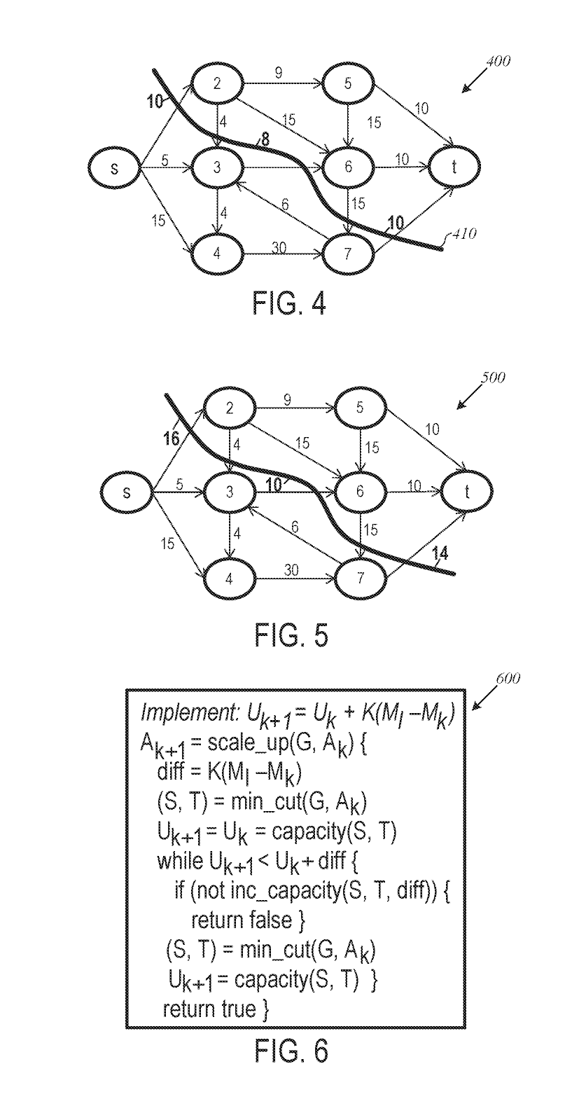

FIG. 4 is a graph 400 of a set of nodes and links provisioned for a distributed application. The graph 400 in one embodiment is an arbitrary directed graph that illustrates node numbers and capacities of the links between the nodes. In one embodiment, a minimum cut (min_cut) function is used to partition (cut) 410 nodes of the graph 400 into two disjoint subsets S and T that are joined by at least one link. The links represent communication in one embodiment, and min_cut function is used to determine under-provisioned links whose capacities should be increased in order to meet the target total capacity. Many different available min_cut functions/algorithms may be used to partition the graph 400. The illustrated cut 410 is represented by min_cut (G)=(S, T)=({s,3,4,7}, {2,5,6,t}). Uₖ=capacity (S,T)=10+8+10=28. In one embodiment, the capacity of every min_cut of G is increased until all of them reach the target capacity, because:

1. max-flow(G)=min_cut (G) capacity=minimal under-provisioned links, and

2. there could be more than one min_cut below the target total capacity.

FIG. 5 is a graph 500 illustrating increased link capacities in order to meet the target total capacity Uₖ₊₁. Note that the target total capacity Uₖ₊₁ at time k+1 has increased by 12 from the current total capacity Uₖ: Uₖ₊₁=28+12=40.

FIG. 6 is a pseudocode representation of an application scale-up method 600 of determining the total increased capacity diff and the under-provisioned nodes and links whose capacities should be increased, and increasing their capacities to meet the increased total increased capacity. Method 600 utilizes the min_cut function to iteratively identify the links between node partitions S and T of an application topology and increase their capacities, until the total increased capacity is met.

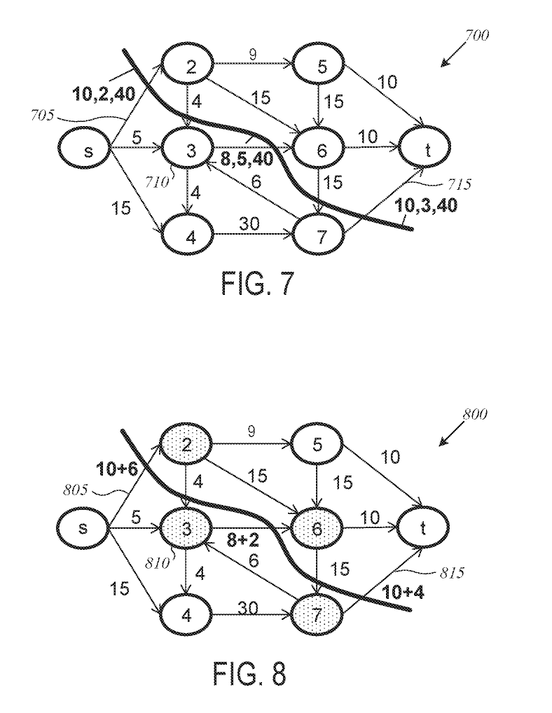

FIG. 7 is a graph 700 illustrating a current capacity along with a cost, and a maximum capacity for each link. For example, a link 705 between a source node (s) and a node (2) is allocated a bandwidth of 10, relative cost of 2, and a maximum capacity of 40. A link 710 between nodes (3) and (4) has a current bandwidth of 8, relative cost of 5, and a maximum capacity of 40. A link 715 between nodes (7) and (t) has a current bandwidth of 10, relative cost of 3, and maximum capacity of 40. In one embodiment, the scaling service indicated that a total increased capacity of 12 should be allocated among three links inversely proportional to their costs. In one embodiment, node capacities may be added to S′={3,7} and T′={2,6} based on node scaling functions f₃, f₇, f₂, f₆ defined by the scaling policy of the application.

FIG. 8 is a graph 800 illustrating changes to graph 700 in accordance with a link-node scale-up algorithm that minimizes cost associated with links and nodes to meet the total increased capacity. The links 705, 710, and 715 have been renumbered in FIG. 8 to begin with “8” as changes to their capacity are now indicated. Link 805, which had the lowest cost, had a capacity increase of 6, link 810, which had the highest cost, hand an increase of 2, and link 815 which had the next lowest cost had an increase of 4, illustrating that the highest cost node had the lowest increase in order to minimize the cost associated with the under-provisioned links.

The link-node scale-up algorithm may be viewed as a solution to a cost optimization problem defined as follows:
Find dᵢⱼ and dᵢ, where dᵢⱼ is a portion of the total increased capacity (diff) allocated to link eᵢⱼ and dᵢ is the increased node capacity for node nᵢ, to minimize sum {dᵢⱼcᵢⱼ for eᵢⱼ in S×T)+sum(dᵢcᵢ for nᵢ in S′=back(S) U T′=front(T)}
Subject to:

1. sum {dᵢⱼ for eᵢⱼ in S×T}=diff

2. aᵢⱼ+dᵢⱼ≦lᵢⱼ

3. bᵢ+dᵢ<lᵢ

4. dᵢ=fᵢ(sum{dᵢⱼ}) for nᵢ in S′ and dᵢ=fᵢ(sum{dⱼᵢ}) for nᵢ in T′ (inc_nodes) dᵢⱼ, dᵢ≧0

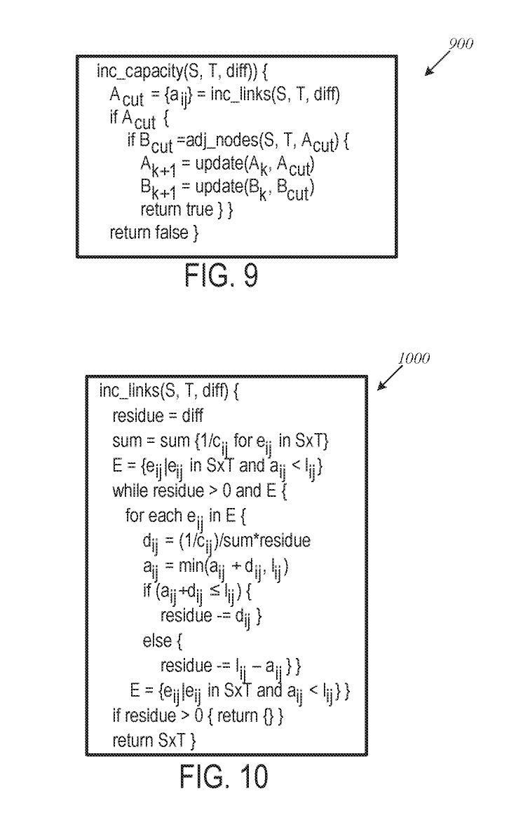

FIG. 9 is a pseudocode representation of a link-node scale-up method 900 of allocating the total increased capacity (diff) among the links between two sets of nodes S and T. The method first utilizes a procedure to increase the capacities of the under-provisioned links to meet the total increased capacity and then utilizes a procedure to adjust the node capacities according to the node scaling functions defined by the scaling policy. These two procedures may produce a target link capacity matrix Aₖ₊₁ and a target node capacity vector Bₖ₊₁ that can be used to increase the link and node capacities of an application.

FIG. 10 is a pseudocode representation of a method 1000 of allocating the total increased capacity among the under-provisioned links to minimize the increased cost due to increased link capacities. The method incrementally divides the total increased capacity among the under-provisioned links inversely proportional to their costs and each link receives an increased capacity within its maximum capacity. If the total increased capacity is received, the procedure stops; otherwise, the residue capacity is treated as the new total increased capacity and the allocation procedure is repeated until the total increased capacity is received or none of the links can receive any increased capacity.

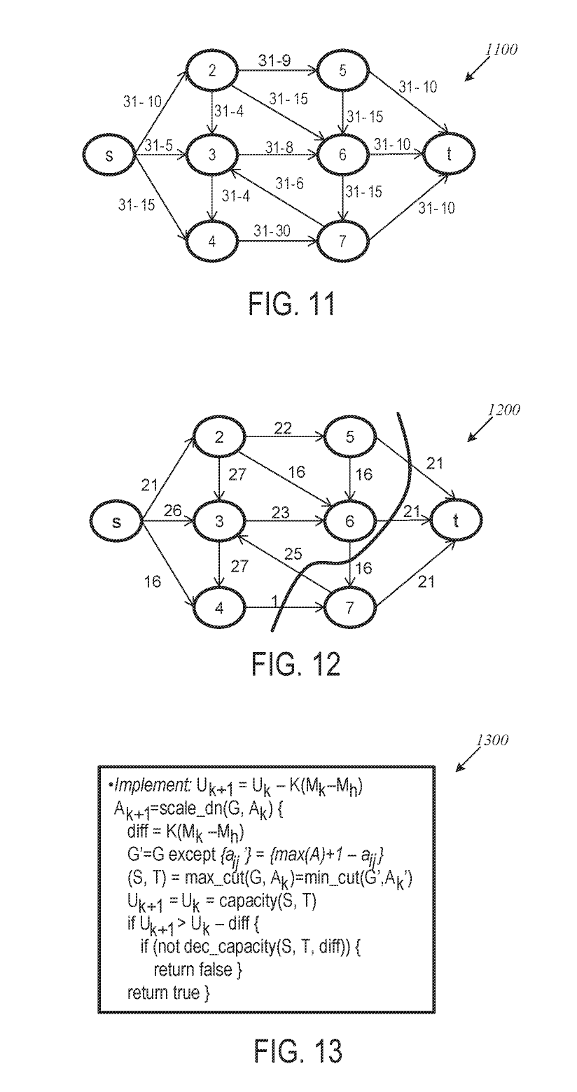

Scaling down may be performed in a similar manner. FIG. 11 is a complement graph 1100 for the distributed application illustrating multiple connected nodes providing a current total capacity of 65. In one embodiment, a decision was made by the scaling service to decrease the current total capacity of the application to a target total capacity of 45. In order to determine the over-provisioned links and nodes of the application, the scaling service constructs a complement graph which is identical to the original graph of the application except the link capacities. For each link with a capacity of aᵢⱼ in the original graph, the corresponding link in the complement graph has capacity max-aᵢⱼ, where max=max {aᵢⱼ}+1. For example, because the link from node 5 to node t in the original graph has capacity 10, the link from node 5 to node t in the complement graph has capacity 31−10=20 for max=31. The over-provisioned links of the application are determined by a max-cut function based on the original graph. The max-function may apply the min_cut function to the complement graph to determine the over-provisioned links: over-provisioned links of G=max-cut(G)=min_cut (G's complement). The scaling service then decreases the capacities of the over-provisioned links and nodes to meet the target total capacity in a manner that maximizes the cost reductions associated with the capacity reductions.

FIG. 12 is a graph 1200 illustrating the over-provisioned nodes and links along the min_cut across the complement graph. The cut partitions the complement graph into two sets S and T, where S={s,2,3,4,5,6} and T={7, t}. Based on this cut, the over-provisioned links are {e₅ₜ, e₆ₜ, e₆₇, e₄₇}. These over-provisioned links provide a total capacity of 10+10+15+30=65. To meet the target capacity of 45, the total capacity has to be decreased by 20, which is the total decreased capacity.

FIG. 13 is a pseudocode representation of an application scale-down method 1300 for scaling down the resources in a cost effective manner. The method first determines the total decreased capacity (diff). It then constructs the complement graph and determines the over-provisioned links and nodes. Finally, it decreases the capacities of the over-provisioned links and nodes to meet the target total capacity.

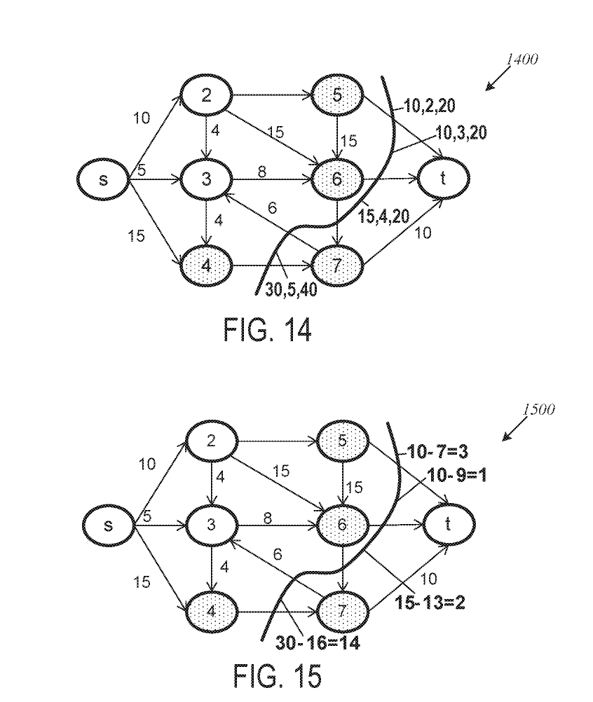

FIG. 14 is a graph 1400 illustrating the complement graph used to determine the decreased capacities for the over-provisioned links and nodes. Link costs and maximum capacities are again shown for certain links that are part of a partition in the min_cut function. In one embodiment, a target capacity of 45 is to be met from the current total capacity of 65. The scaling service determines that four over-provisioned links will decrease their capacities by 20 in total proportional to their costs to meet the target total capacity. In one embodiment, node capacity is removed from S′={5,6,4} and T′={7} based on node scaling functions f₅, f₆, f₄, and f₇ defined by the scaling policy of the application.

The allocation of total decreased capacity among the over-provisioned links may be defined as a solution to the following optimization problem:
Find dᵢⱼ and dᵢ, where dᵢⱼ is the decreased link capacity and dᵢ is the decreased node capacity, to maximize sum {dᵢⱼcᵢⱼ for eᵢⱼ in S×T}+sum{dᵢcᵢ for nᵢ in S′=back(S) U T′=front(T)}
Subject to:

1. sum {dᵢⱼ for eᵢⱼ in S×T}=diff

2. 0<aᵢⱼ−dᵢⱼ

3. 0<bᵢ−dᵢ

4. dᵢ=fᵢ(−sum{dᵢⱼ}) for nᵢ in S′ and dᵢ=fᵢ(−sum{dᵢ}) for nᵢ in T′(dec_nodes)

5. dᵢⱼ,dᵢ≧0

FIG. 15 is a graph 1500 that illustrates the changes to the capacities of over-provisioned links, where the more costly links receive more decreased capacities, in order to meet the total decreased capacity of 20. For example, the link from node 4 to node 7 receives the highest decreased capacity of 16 because it has the highest cost of 5 among the over-provisioned links.

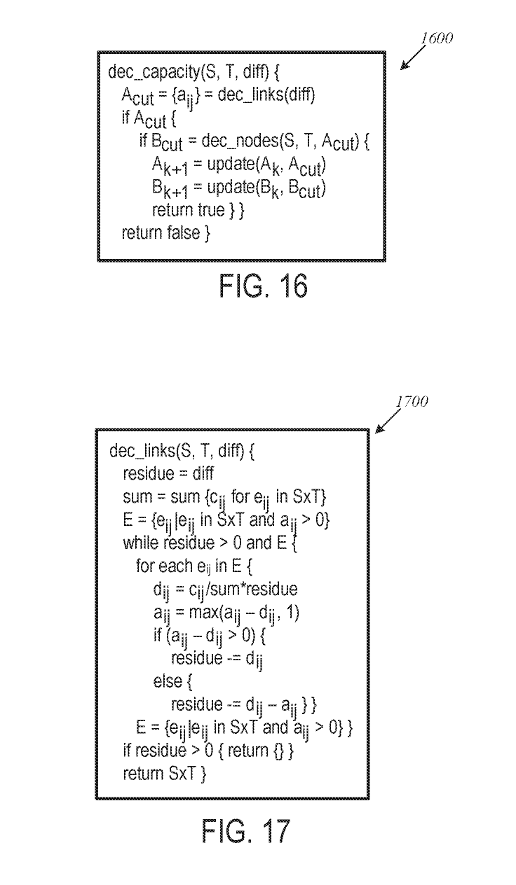

FIG. 16 is a pseudocode representation of a link-node scale down method 1600 of allocating the total decreased capacity among the over-provisioned nodes and links to achieve the link-node scale down illustrated in graphs 1400 and 1500 in a cost effective manner. The method first uses a procedure to determine the decreased capacities of the over-provisioned links and then it uses a procedure to determine the decreased capacities of the nodes associated with the over-provisioned links. The method may produce a target link capacity matrix Aₖ₊₁ and a target node capacity vector Bₖ₊₁ used to update the link and node resources of the application.

FIG. 17 is a pseudocode representation of a method 1700 of allocating total decreased capacity among the over-provisioned links to achieve the link-node scale down illustrated in graphs 1400 and 1500. The method divides the total decreased capacity (diff) among the over-provisioned links proportional to their costs and each link receives a decreased link capacity greater than zero. If the total decreased capacity is received, the procedure stops; otherwise, the residue capacity is treated as the new total decreased capacity the allocation procedure repeats, until the total decreased capacity is received or none of the links can receive any capacity reduction.

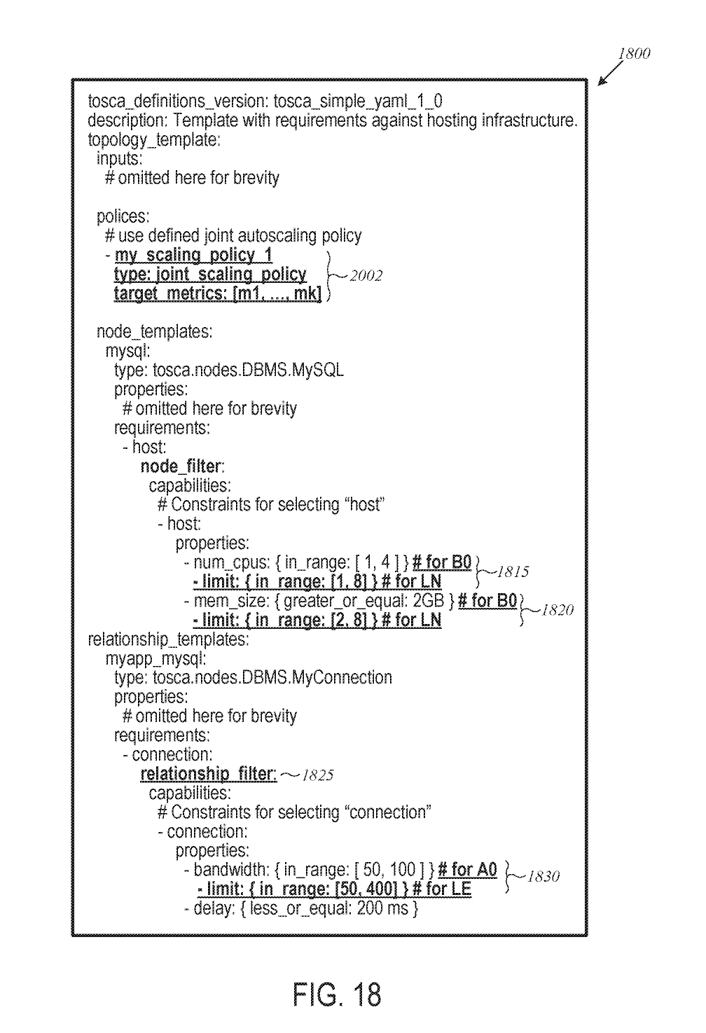

FIG. 18 is a YAML representation 1800 illustrating changes to OASIS (an organization advancing open standards for the information society) TOSCA standard for describing the application topology, initial resource specification and scaling policy. A policy extension is shown at 1810 and includes a joint scaling policy and target metrics. Node_filter properties have also been extended to include specification of CPU limits at 1815 and memory size limits at 1820, both of which are underlined to illustrate the extended portions. A relationship filter indicated at 1825 has also been added with a bandwidth limit added at 1830.

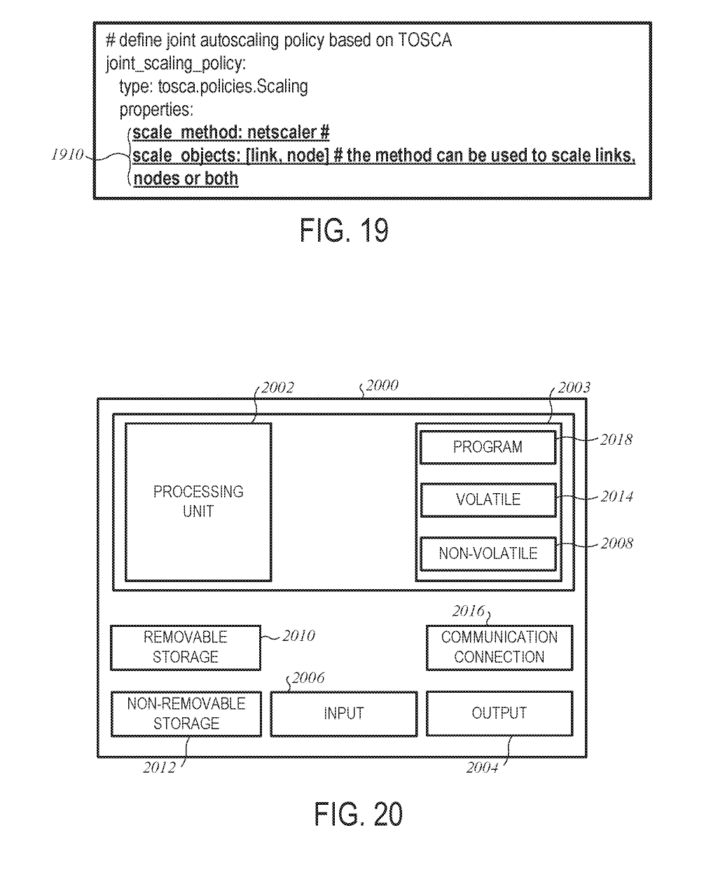

FIG. 19 is a pseudocode representation 1900 illustrating a joint auto-scaling policy based on TOSCA, where a scaling method as described herein to scale links, nodes, or both, and scaling objects have been added as indicated at 1910. Together, FIGS. 18 and 19 specify the joint auto-scaling policy and parameters of the cloud based distributed application in TOSCA, which is converted to a flow network model.

FIG. 20 is a block diagram illustrating circuitry for clients, servers, cloud based resources for implementing algorithms and performing methods according to example embodiments. All components need not be used in various embodiments. For example, the clients, servers, and network resources may each use a different set of components, or in the case of servers for example, larger storage devices.

Various described embodiments may provide one or more benefits for users of the distributed application. The scaling policy may be simplified as there is no need to specify complex scaling rules for different scaling groups. Users can jointly scale links and nodes of applications, avoiding the delays observed in reactive scaling using individual and independent scaling policies of nodes and links. Cost for joint resources (compute and network) maybe reduced while maintaining the performance of the distributed application. For cloud providers, joint resource utilization (compute and network) may be provided while providing global performance improvement to applications. Proactive auto-scaling based on application topology results in improved efficiency, reducing delays observed with prior cascading reactive methods of auto-scaling. Still further, the min_cut methodology, the application scaling, and the link-node scaling algorithms are all polynomial time, reducing the overhead required for identifying resources to scale.

One example computing device in the form of a computer 2000 may include a processing unit 2002, memory 2003, removable storage 2010, and non-removable storage 2012. Although the example computing device is illustrated and described as computer 2000, the computing device may be in different forms in different embodiments. For example, the computing device may instead be a smartphone, a tablet, smartwatch, or other computing device including the same or similar elements as illustrated and described with regard to FIG. 20. Devices, such as smartphones, tablets, and smartwatches, are generally collectively referred to as mobile devices or user equipment. Further, although the various data storage elements are illustrated as part of the computer 2000, the storage may also or alternatively include cloud-based storage accessible via a network, such as the Internet or server based storage.

Memory 2003 may include volatile memory 2014 and non-volatile memory 2008. Computer 2000 may include—or have access to a computing environment that includes—a variety of computer-readable media, such as volatile memory 2014 and non-volatile memory 2008, removable storage 2010 and non-removable storage 2012. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 2000 may include or have access to a computing environment that includes input 2006, output 2004, and a communication connection 2016. Output 2004 may include a display device, such as a touchscreen, that also may serve as an input device. The input 2006 may include one or more of a touchscreen, touchpad, mouse, keyboard, camera, one or more device-specific buttons, one or more sensors integrated within or coupled via wired or wireless data connections to the computer 2000, and other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the processing unit 2002 of the computer 2000. A hard drive, CD-ROM, and RAM are some examples of articles including a non-transitory computer-readable medium such as a storage device. The terms computer-readable medium and storage device do not include carrier waves to the extent carrier waves are deemed too transitory. For example, a computer program 2018 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 2000 to provide generic access controls in a COM based computer network system having multiple users and servers. Storage can also include networked storage such as a storage area network (SAN) indicated at 2020.

### Examples

1. In example 1, a method includes receiving runtime metrics for a distributed application, the distributed application utilizing cloud resources including computer nodes and network links, detecting a change in runtime metrics, determining nodes and links associated with the distributed application utilizing an application topology description data structure, and jointly scaling the links and nodes responsive to the detected change in runtime metrics.

2. The method of example 1 wherein the links and nodes are scaled in accordance with an auto-scaling policy.

3. The method of example 2 wherein the auto-scaling policy is associated with the distributed application.

4. The method of any of examples 1-3 wherein scaling the nodes comprises adjusting resources at multiple nodes of the application.

5. The method of example 4 wherein scaling the links comprises adjusting bandwidths of networks between the multiple nodes.

6. The method of any of examples 1-5 wherein the application topology description data structure includes an initial reference value for the runtime metrics for the distributed application.

7. The method of example 6 wherein the application topology description data structure further includes link capacities, node capacities, maximum link capacity, maximum node capacity, link cost, node cost, source node, and sink node.

8. The method of example 6 wherein auto-scaling the links and nodes is performed using an integral control algorithm to generate a change from current total capacity to a target total capacity for the application.

9. The method of example 8 wherein the capacities of links and nodes are scaled up or down or remain the same dependent on a target capacity, and wherein a target total capacity is calculated based on a pair of high and low threshold metrics.

10. The method of example 9 wherein under-provisioned links and nodes are identified using a graph min_cut method based on the application topology and capacities of under-provisioned links and nodes are increased to meet the target total capacity such that cost of the under-provisioned links and nodes is reduced by iteratively allocating total increased capacity among the links inversely proportional to their costs.

11. The method of example 9 wherein over-provisioned links and nodes are identified using a graph max-cut method based on the application topology and capacities of over-provisioned links and nodes are decreased to meet the target total capacity such that cost of the over-provisioned links and nodes is reduced by iteratively allocating total decreased capacity among the links proportional to their costs.

12. The method of any of examples 1-11 wherein the distributed application comprises a tiered web application with different nodes performing different tiers of the web application.

13. In example 13, a computer implemented auto-scaling system includes processing circuitry, a storage device coupled to the processing circuitry, and auto-scaling code stored on the storage device for execution by the processing circuitry to perform operations. The operations include receiving runtime metrics for a distributed application, the distributed application utilizing cloud resources including computer nodes and network links, detecting a change in runtime metrics, determining nodes and links associated with the distributed application utilizing an application topology description data structure, and jointly scaling the links and nodes responsive to the detected change in runtime metrics.

14. The system of example 13 wherein the links and nodes are scaled in accordance with an auto-scaling policy.

15. The system of example 14 wherein the auto-scaling policy is associated with the distributed application and wherein the processing circuitry comprises cloud based resources.

16. The system of any of examples 13-15 wherein auto-scaling the links and nodes comprises adjusting resources at multiple nodes of the application, wherein scaling the links comprises adjusting bandwidths of networks between the multiple nodes, wherein the application topology description data structure includes an initial reference value for the runtime metrics for the distributed application, and wherein the application topology description data structure further includes link capacities, node capacities, maximum link capacity, maximum node capacity, link cost, node cost, source node, and sink node.

17. The system of example 16 wherein auto-scaling the links and nodes is performed using an integral control algorithm to generate a change from current total capacity to a target total capacity for the entire application (or the entire services to support the application), wherein a target total capacity is calculated based on a pair of high and low threshold metrics, wherein under-provisioned links and nodes are identified using a graph min_cut method based on the application topology and capacities of under-provisioned links and nodes are increased to meet the target total capacity such that cost of the under-provisioned links and nodes is minimized by iteratively allocating total increased capacity among the links inversely proportional to their costs, and wherein over-provisioned links and nodes are identified using a graph max-cut method based on the application topology and capacities of over-provisioned links and nodes are decreased to meet the target total capacity such that cost of the over-provisioned links and nodes is minimized (or compared and/or reduced) by iteratively allocating total decreased capacity among the links proportional to their costs.

18. In example 18, a non-transitory storage device has instructions stored thereon for execution by processor to cause the processor to perform operations including receiving runtime metrics for a distributed application, the distributed application utilizing cloud resources including computer nodes and network connections, detecting a change in runtime metrics, determining nodes and links associated with the distributed application utilizing an application topology description data structure, and jointly scaling the links and nodes responsive to the detected change in distributed application workload metrics.

19. The non-transitory storage device of example 18 wherein auto-scaling the links and nodes comprises adjusting resources at multiple nodes of the application, wherein scaling the links comprises adjusting bandwidths of networks between the multiple nodes, wherein the application topology description data structure includes an initial reference value for the runtime metrics for the distributed application, and wherein the application topology description data structure further includes link capacities, node capacities, maximum link capacity, maximum node capacity, link cost, node cost, source node, and sink node.

20. The non-transitory storage device of example 19 wherein auto-scaling the links and nodes is performed using an integral control algorithm to generate a change from current total capacity to a target total capacity for the entire application, wherein a target total capacity is calculated based on a pair of high and low threshold metrics, wherein under-provisioned links and nodes are identified using a graph min_cut method based on the application topology and capacities of under-provisioned links and nodes are increased to meet the target total capacity such that cost of the under-provisioned links and nodes is reduced by iteratively allocating total increased capacity among the links inversely proportional to their costs, and wherein over-provisioned links and nodes are identified using a graph max-cut method based on the application topology and capacities of over-provisioned links and nodes are decreased to meet the target total capacity such that cost of the over-provisioned links and nodes is reduced by iteratively allocating total decreased capacity among the links proportional to their costs.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
receiving runtime metrics for a distributed application, the distributed application utilizing cloud resources including computer nodes and network links;
detecting a change in the runtime metrics;
determining nodes and links associated with the distributed application utilizing an application topology description data structure; and
jointly scaling the links and nodes responsive to the detected change in the runtime metrics.

2. The method of claim 1 wherein the links and nodes are scaled in accordance with an auto-scaling policy.

3. The method of claim 2 wherein the auto-scaling policy is associated with the distributed application.

4. The method of claim 1 wherein scaling the nodes comprises adjusting resources at multiple nodes of the application.

5. The method of claim 4 wherein scaling the links comprises adjusting bandwidths of networks between the multiple nodes.

6. The method of claim 1 wherein the application topology description data structure includes an initial reference value for the runtime metrics for the distributed application.

7. The method of claim 6 wherein the application topology description data structure further includes link capacities, node capacities, maximum link capacity, maximum node capacity, link cost, node cost, source node, and sink node.

8. The method of claim 6 wherein auto-scaling the links and nodes is performed using an integral control algorithm to generate a change from current total capacity to a target total capacity for the application.

9. The method of claim 8 wherein the capacities of links and nodes are scaled up or down or remain the same dependent on a target capacity, and wherein the target total capacity is calculated based on a pair of high and low threshold metrics.

10. The method of claim 9 wherein under-provisioned links and nodes are identified using a graph min_cut method based on the application topology and capacities of under-provisioned links and nodes are increased to meet the target total capacity such that cost of the under-provisioned links and nodes is reduced by iteratively allocating total increased capacity among the links inversely proportional to their costs.

11. The method of claim 9 wherein over-provisioned links and nodes are identified using a graph max-cut method based on the application topology and capacities of over-provisioned links and nodes are decreased to meet the target total capacity such that cost of the over-provisioned links and nodes is reduced by iteratively allocating total decreased capacity among the links proportional to their costs.

12. The method of claim 1 wherein the distributed application comprises a tiered web application with different nodes performing different tiers of the web application.

13. A computer implemented auto-scaling system comprising:
processing circuitry;
a storage device coupled to the processing circuitry; and
auto-scaling code stored on the storage device for execution by the processing circuitry to perform operations comprising:
receiving runtime metrics for a distributed application, the distributed application utilizing cloud resources including computer nodes and network links;
detecting a change in the runtime metrics;
determining nodes and links associated with the distributed application utilizing an application topology description data structure; and
jointly scaling the links and nodes responsive to the detected change in the runtime metrics.

14. The system of claim 13 wherein the links and nodes are scaled in accordance with an auto-scaling policy.

15. The system of claim 14 wherein the auto-scaling policy is associated with the distributed application and wherein the processing circuitry comprises cloud based resources.

16. The system of claim 13 wherein auto-scaling the links and nodes comprises adjusting resources at multiple nodes of the application, wherein scaling the links comprises adjusting bandwidths of networks between the multiple nodes, wherein the application topology description data structure includes an initial reference value for the runtime metrics for the distributed application, and wherein the application topology description data structure further includes link capacities, node capacities, maximum link capacity, maximum node capacity, link cost, node cost, source node, and sink node.

17. The system of claim 16 wherein auto-scaling the links and nodes is performed using an integral control algorithm to generate a change from current total capacity to a target total capacity for the application, wherein a target total capacity is calculated based on a pair of high and low threshold metrics, wherein under-provisioned links and nodes are identified using a graph min_cut method based on the application topology and capacities of under-provisioned links and nodes are increased to meet the target total capacity such that cost of the under-provisioned links and nodes is reduced by iteratively allocating total increased capacity among the links inversely proportional to their costs, and wherein over-provisioned links and nodes are identified using a graph max-cut method based on the application topology and capacities of over-provisioned links and nodes are decreased to meet the target total capacity such that cost of the over-provisioned links and nodes is reduced by iteratively allocating total decreased capacity among the links proportional to their costs.

18. A non-transitory storage device having instructions stored thereon for execution by processor to cause the processor to perform operations comprising:
receiving runtime metrics for a distributed application, the distributed application utilizing cloud resources including computer nodes and network connections;
detecting a change in the runtime metrics;
determining nodes and links associated with the distributed application utilizing an application topology description data structure; and
jointly scaling the links and nodes responsive to the detected change in distributed application workload metrics.

19. The non-transitory storage device of claim 18 wherein auto-scaling the links and nodes comprises adjusting resources at multiple nodes of the application, wherein scaling the links comprises adjusting bandwidths of networks between the multiple nodes, wherein the application topology description data structure includes an initial reference value for the runtime metrics for the distributed application, and wherein the application topology description data structure further includes link capacities, node capacities, maximum link capacity, maximum node capacity, link cost, node cost, source node, and sink node.

20. The non-transitory storage device of claim 19 wherein auto-scaling the links and nodes is performed using an integral control algorithm to generate a change from current total capacity to a target total capacity for the application, wherein a target total capacity is calculated based on a pair of high and low threshold metrics, wherein under-provisioned links and nodes are identified using a graph min_cut method based on the application topology and capacities of under-provisioned links and nodes are increased to meet the target total capacity such that cost of the under-provisioned links and nodes is reduced by iteratively allocating total increased capacity among the links inversely proportional to their costs, and wherein over-provisioned links and nodes are identified using a graph max-cut method based on the application topology and capacities of over-provisioned links and nodes are decreased to meet the target total capacity such that cost of the over-provisioned links and nodes is reduced by iteratively allocating total decreased capacity among the links proportional to their costs.
